(19) United States
(12) Patent Application Publication
(10) Pub. No.: US 2023/0128246 A1
(43) Pub. Date: Apr. 27, 2023

(54) COLLABORATIVE ELECTRONIC PLATFORM FOR PREDICTING NON-PAYMENTS FOR COMPANIES AND ASSOCIATED METHOD

(71) Applicant: Tradein Holding, Lille (FR)

(72) Inventor: Jean-Cedric BEKALE BE NTOUTOUME, Sainit Germain en Laye (FR)

(21) Appl. No.: 17/995,034

(22) PCT Filed: Mar. 31, 2021
(86) PCT No.: PCT/FR2021/050564

§ 371 Date: Sep. 29, 2022

(30) Foreign Application Priority Data
Mar. 31, 2020 (FR) FR2003218

(51) Int. Cl. G06Q 10/0635; G06Q 20/10; G06Q 20/14; G06Q 20/38; G06Q 30/04

(52) U.S. Cl. CPC G06Q 10/0635; G06Q 20/102; G06Q 20/14; G06Q 20/389; G06Q 30/04

(57) ABSTRACT

A collaborative electronic platform for predicting payment defaults between an enterprise and customers of said enterprise, including a data storage system, at least one computer server and processing and computing means implementing at least one machine learning model, the platform being able to import financial data of the enterprise, the model estimating the occurrence of payment defaults on the part of customers on the basis of the financial data imported, the platform being connected to a plurality of enterprises forming a community sharing information in real time on the platform, able to transmit any information shared by a first enterprise to at other enterprises in the community for which the information has an interest, and including an application programming interface API for executing a risk-management user program on terminals of the enterprises in the community.

### CROSS-REFERENCE TO RELATED APPLICATIONS

This application is a National Stage of International Application No. PCT/FR2021/050564, having an International Filing Date of 31 Mar. 2021, which designated the United States of America, and which International Application was published under PCT Article 21(2) as WO Publication No. 2021/198615 A1, which claims priority from and the benefit of French Patent Application No. 2003218, filed on 31 Mar. 2020, the disclosures of which are incorporated herein by reference in their entireties.

### BACKGROUND

### 1. Field

The present disclosure relates to the general field of financial and insurance technologies (fintech and insurtech), in particular the automation of risk management, and relates more particularly to a collaborative electronic platform for predicting payment defaults between enterprises, such as payment delays and unpaid invoices, by machine learning, and a method implemented by said platform.

The disclosure also relates to blockchain, big-data management and decision-aiding techniques.

### 2. Brief Description of Related Developments

The effective management of sales is important for the overall financial health of a business. Enterprises seek to reduce unpaid debts and to guard against the consequences of the accumulation of delays in payment and unpaid invoices. One of the major problems encountered essentially by small or medium enterprises is that of delays in payment which, often, leads to the cessation of business and the premature stoppage of enterprises, including those with great economic potential.

In France, by way of example, the problem of delays in payment leads annually to more than twelve thousand enterprises going bankrupt according to some estimates. However, some of the enterprises concerned have taken out conventional credit insurance to guard against the financial risks related in particular to payment defaults on the part of their customers.

Furthermore, recurrent payment defaults suffered by a company have an impact on its cash flow and do not able it to deal with its various financing requirements with equanimity, requirements to which insurers do not provide satisfactory solutions. Because of this, some enterprises, especially subcontractors, do not have available effective and beneficial financing tools. Despite the fact that priority must be given to reducing payment times, it is also essential to assist enterprises more to best deal with their cash-flow requirements.

The credit insurance companies that currently dominate the market offer to assist enterprises in avoiding doubtful debts and poor payers, by giving them opinions about the customers or prospects with which said enterprises wish to work. These opinions are simply based on a network of risk experts, who continuously analyze the financial data of enterprises, the industrial sectors, the contextual risks (country, events, etc.) and other factors, in order to alert the insured enterprises about the potential risks.

This approach is absolutely not suited to very small, small or medium enterprises, who do not necessarily have the privilege of being closely guided by experts, experts who, in addition, cannot analyze the phenomenal quantity of data generated by this complex economic fabric of VSE/SMEs, cannot make themselves available for each doubtful financial transaction, cannot integrate the influence of contextual and behavioral data as a machine learning model would do, etc.

Recent technological advances such as blockchain, big data, the Internet of Things and artificial intelligence now make it possible to create novel solutions that no longer leave any place for human action in the pre-decisional analysis of a complex problem such as that of the prediction of payment defaults.

The document US 2019/287182 A1, in the name of American Express, describes a method for establishing a conformity score for a consumer from a history of transactions, having information associated with a plurality of transactions, by means of an artificial neural network. This solution does not make it possible to predict a score for prospects and does not take account of data external to the consumer.

The document US 2018/232814 A1, in the name of Oracle, proposes using machine learning models for estimating a payment default on an invoice. Multiple models for estimating payment defaults are generated from a plurality of invoices distributed in training sets. This solution, also personal, does not allow any use of external data or of “collective” data coming from other users.

No solution, to the knowledge of the applicant, currently makes it possible to use information shared in real time by a community of enterprises around a centralized platform for predicting payment defaults, including with regard to new customers for which the enterprise concerned does not yet have any payment history, the missing information being supplied by other enterprises when the data is shared.

### SUMMARY

The present disclosure aims to overcome the drawbacks of the prior art disclosed above, in particular the absence of credit-risk management solutions adapted to small or medium enterprises and making it possible to institute a mutual-assistance community sharing information between a plurality of enterprises.

For this purpose, the object of the present disclosure is a collaborative electronic platform for predicting payment defaults between an enterprise and customers of said enterprise, comprising a data storage system, at least one computer server and processing and computing means implementing at least one machine learning model, the platform being able to import financial data of the enterprise by means of a secure connection between the data storage system and an internal management tool of said enterprise, said model estimating the occurrence of payment defaults on the part of customers on the basis of the financial data imported. This collaborative platform is remarkable in that it is connected to a plurality of enterprises forming a community sharing information in real time on the platform, in that it is able to transmit any information shared by a first enterprise to at least one second enterprise in the community for which said information has an interest, and in that it comprises an application programming interface API for executing a risk-management user program on terminals of the enterprises in the community.

Advantageously, the collaborative platform is connected to external data sources, and the processing and computing means include notation algorithms for determining a score for any enterprise from information on said enterprise contained in the external data imported by said platform.

According to a particularly advantageous embodiment, the collaborative platform has a cloud architecture with a virtualization layer comprising at least the data storage system and any server, said platform being accessible via a network of the internet type.

According to one embodiment, the data storage system comprises a database and the processing and computing means comprise at least one processor, said database being able to be distributed on a blockchain.

Advantageously, the information shared by the member enterprises of the community comprise payment histories of the customers of each enterprise, and the financial data imported comprise customer portfolios, invoices, quotations, etc.

According to the disclosure, at least one machine learning model constructs a payment-default prediction on an invoice from attributes relating to said invoice, financial data imported on the platform and contextual data.

Another object of the present disclosure is a method for predicting risks related to payment defaults between an enterprise and customers of said enterprise, implemented by a collaborative platform as has been presented, characterized in that it comprises:
an initial step of subscribing the enterprise to the platform;
a step of exporting data from an internal management tool of the enterprise to the data storage system of the platform;
an analysis and prediction step using at least one machine learning model;
a step of presenting, on a terminal of the enterprise, information based on results of the previous step.

More particularly, the analysis and prediction step uses data supplied by a plurality of enterprises in the community as well as external data coming from sources such as financial data providers, and makes it possible also to detect payment defaults by taking account of maturity times of invoices imported onto the platform.

Advantageously, the information presentation step produces prevention information comprising at least one item of information from a risk alert, a credit risk score and an information report, the latter corresponding to the risk profile of a customer of the enterprise.

According to one embodiment, the method furthermore comprises an operation or a combination of operations from: a reimbursement of unpaid invoices in favor of enterprises in the community (debt recovery), in accordance with a risk mutualization system centralized in the collaborative platform and secured by a blockchain; a mutualized financing of customer invoices, between enterprises that are members of the community, in accordance with a peer-to-peer financing model managed by the collaborative platform and secured by the blockchain; and a prediction of the cash flow of each enterprise in the community on the basis of the data imported into said platform.

The fundamental concepts of the disclosure having been disclosed above in the most elementary form thereof, other details and features will emerge more clearly from the reading of the following description with regard to the accompanying drawings, giving by way of non-limitative example embodiments of a collaborative platform and of an associated risk prevention method, in accordance with the principles of the disclosure.

### BRIEF DESCRIPTION OF THE DRAWINGS

The figures are given purely for illustrative purposes for an understanding of the disclosure and do not limit the scope thereof. In all the figures, the identical or equivalent elements bear the same numerical reference.

There are thus illustrated in:

FIG. 1: an outline diagram of a collaborative platform according to one aspect of the disclosure;

FIG. 2: a block diagram of the collaborative platform interacting with a community of enterprises;

FIG. 3: an example of system architecture of the collaborative platform according to the disclosure;

FIG. 4: an example of information exchanged between the collaborative platform and an enterprise that is a member of the community;

FIG. 5: the main steps of a payment-default risk prevention method according to one embodiment of the disclosure;

FIG. 6: an example of graphical interface on a mobile application for interacting with the collaborative platform;

FIG. 7A: an example of presentation of information on the mobile application;

FIG. 7B: another example of presentation of information;

FIG. 8: a partial block diagram of a machine learning model executed in the collaborative platform;

FIG. 9: the main steps of a method for mutualizing risks between members of the community according to an embodiment of the disclosure.

### DETAILED DESCRIPTION

It should first be noted that some well known devices, systems and methods are described and explained here to avoid any insufficiency or ambiguity in an understanding of the present disclosure.

In the embodiments described below, reference is made to a computer system, in the form of a collaborative electronic platform, for predicting payment defaults between enterprises, intended mainly for entities of the small or medium enterprise (SME) type in order to enable them to better manage the financial risks inherent in payment defaults, such as delays in payment and unpaid invoices, on the part of their customers, but also a decisional aid in the selection of their prospects. This non-limitative example is given for a better understanding of the disclosure and does not exclude the use of the collaborative platform in other industrial and economic contexts for predicting risk events.

It should be stated that, in any economic chain, payment defaults constitute a major risk and cause a cascade effect for the enterprises. This risk proves to be critical for the most fragile enterprises, the activity of which may be put in danger because of payment delays practiced by their customers, or at least, negligible for enterprises with a greater scale, but impacting on their cash flow or even limiting their growth.

The remainder of the description is in the particular context of French and/or European regulations and the abbreviation SME designates small or medium enterprises. Nevertheless, it must be emphasized that the limits, in terms of staffing and turnover, defining the size of the enterprises, vary from one country to another. “SME” will therefore designate by extension any equivalent category of enterprise.

FIG. 1 shows in a simplified manner the operating principle of a collaborative platform 10 according to a first aspect of the disclosure. The collaborative platform 10 makes it possible to combine a plurality of enterprises 20 in an information-sharing community, said enterprises bearing the references E1, E2 and E3 so as to be distinguished from each other in this particular case. Thus each enterprise can share in real time with the other enterprises in the community its customer payment experiences, or in other words the state of payment or the accounting status of its invoices, so as to enable the collaborative platform to establish behavior profiles of the customers of each enterprise in the community, C1 to C6 on FIG. 1. The collaborative platform 100 makes it possible in fact to compile the various data coming from payment histories supplied by the enterprises 20 in the community and to address preventive recommendations to said enterprises on the basis of statistical analyses and/or machine learning models described below.

For example, when an enterprise E1 that is a member of the community, in other words using the collaborative platform 10, is the subject of a payment default N11 on the part of its customer C1, this payment default is automatically shared on the collaborative platform 10, which takes account of it in attributing an updated score S1 to the customer C1. According to one aspect of the disclosure detailed below, the collaborative platform 10 attributes a score in accordance with a precise notation to each customer of the enterprises in the community and to any other entity liable to be solicited by a current or future member of said platform, these scores reflecting the payment behaviors. Obviously, the payment defaults noted have a negative impact on the scores attributed by the platform 10 to the defaulting enterprises. In the same way, the good behavior P25 of the customer C5 in its commercial relationship, especially its financial transactions, with the enterprise E2 is shared on the collaborative platform and has a positive impact on the score S5 of said customer. Next the enterprise E3, also a member of the community, in seeking a prospect, is informed in real time of the scores of the prospects that it is targeting, in particular scores of C1 and C5. The negative score S1 of C1 enables the collaborative platform 10 to advise E3 against a transaction T31 with C1. On the other hand, the good score S5 of the prospect C5, a customer of E2, makes it possible to encourage the enterprise E3 to undertake a transaction T35 with said prospect.

The above simplified example, apart from the summary functions of the collaborative platform, discloses the main objectives thereof and emphasizes the importance of a behavioral analysis of the customers in predicting payment defaults. This is because the causes of a payment default are not necessarily limited to a business failure in the normal sense (involving filing for bankruptcy), in which case the payment default would be predictable since it would be correlated with an event that was predictable in the short term. Often, payment defaults quite simply correspond to deadlines that are intentionally not honored, and are therefore difficult to predict in the case of unknown prospects. Hence the interest of prior knowledge of the behavior of the prospects, knowledge made possible by virtue of the sharing of information on the collaborative platform and the resources available.

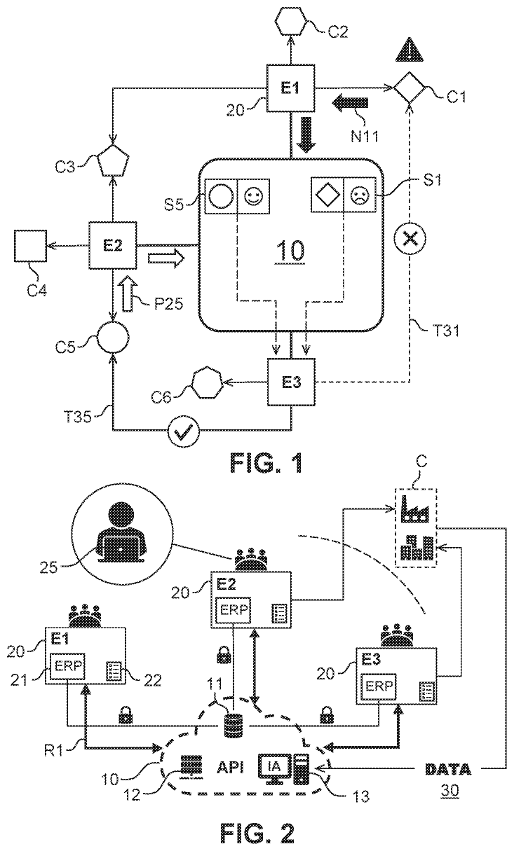

FIG. 2 shows schematically the collaborative platform 10 interacting with the main actors, namely the enterprises 20 that are members of the community and the prospects/customers C, for the purpose of providing to said enterprises an aid to decision, in the form of recommendations and information, enabling them best to manage the payment default risks, to select reliable prospects and/or to extend or break a contract with a customer.

For this purpose, the collaborative platform 10 mainly comprises a data storage system 11, one or more computer servers 12, processing and computing means 13 implementing artificial intelligence algorithms, and an application programming interface API for making the connection between a local program and consumer programs executed at the enterprises 20. The collaborative platform 10 may be physical or preferably virtual, in which case it has a virtualization layer containing all or some of the aforementioned elements, in particular the storage system 11 and the servers 12, so as to obtain a cloud architecture, commonly referred to as cloud computing, offering said platform advantageous agility and computing capacity.

Thus the collaborative platform 10 is accessible by means of a network of the internet type and may be in the form of software as an SaaS (Software as a Service), or as a supplier program accessible via the API by consumer programs. Preferably, the collaborative platform 10 is a web-based SaaS.

The storage system 11, according to one embodiment of the disclosure, is a cloud database to which, in a secure fashion, each enterprise 20 in the community connects by means of internal management software 21 such as an ERP (Enterprise Resource Planning) integrated management package, for sharing information on the collaborative platform 10. Information can be shared with the platform in a different way. The database 11 thus enables each enterprise 20 that is a member of the community to contribute by customer/prospect data 22, such as customer portfolios and invoicing records, necessary for training machine learning models used by the computing means 13. The connection between the management software 21 and the database 11 may require a specific interfacing program (gateway) that would for example be installed at the user, namely the member enterprise, prior to the use of the collaborative platform 10.

The database 11, according to one embodiment, is distributed on a blockchain for securing the internal data supplied by the enterprises 20 in the community to the collaborative platform 10. In addition, this blockchain is advantageously used for securing transactions from/between members of the community, provided by the collaborative platform as explained below, by having recourse to electronic signatures and to smart contracts.

The computing means 13, according to one embodiment, corresponds to processing and computing units, of the computer type, on which specific programs are installed for processing data and executing machine learning models by one or more processors. The data processing operations implemented relate in particular to big data arriving on the collaborative platform 10 coming from a multitude of sources.

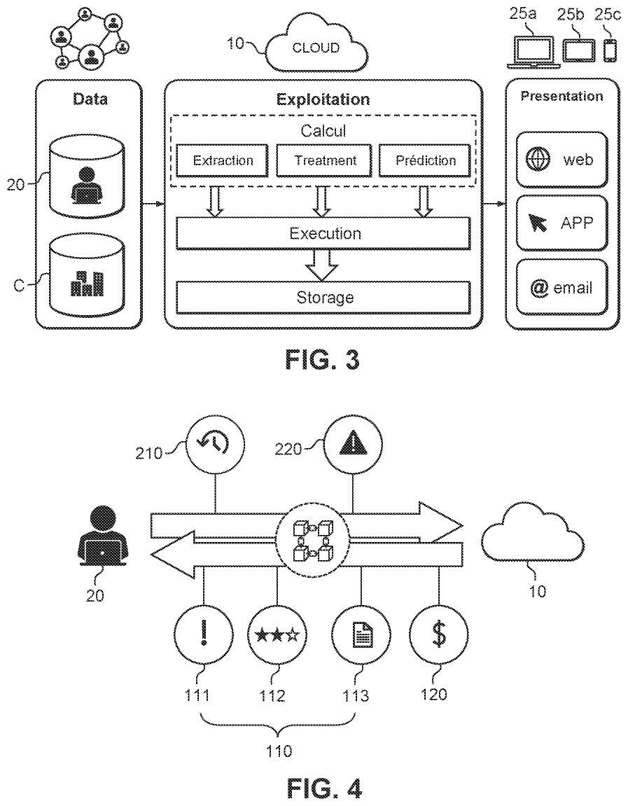

The collaborative platform 10 is available on the network and accessible to the enterprises 20 that are members of the community, subject to certain subscription conditions, by means of various terminals 25 and personal communication and assistance means, shown in FIG. 3, such as a computer 25a, via a web interface, a digital tablet 25b and a smartphone 25c, via dedicated mobile applications. Access to the collaborative platform 10 is therefore facilitated for adapting to remote management and to a quasi-permanent connection, according to a working mode more and more adopted by the managers of enterprises of the startup type.

Thus, between the collaborative platform 10 and each enterprise 20 that is a member of the community, a data exchange relationship is instigated, the relationship R1 in the case of the enterprise E1 on FIG. 2, through which said platform collects varied data coming from the community and customers and prospects C of the community. The latter case corresponds to data external to the community, which will be referred to as external data 30, and the sources of which will be listed later. Among the external data 30, contextual data can be collected by means of specialist sources and bodies and will participate in establishing predictions of payment defaults suffered by the enterprises 20 and in calculating scores for the customers/prospects of said enterprises.

FIG. 3 shows the overall system architecture of the collaborative platform 10 that is organized in three paradigms: data collection, data use and presentation of information. It will easily be understood that the enterprises 20 that are members of the community, through their use of the collaborative platform 10, are both a source of data and a target (destinations) of information transformed in the cloud. This finding will be explained in the reading of FIG. 4.

Still with reference to FIG. 3, the data collected by the collaborative platform 10 comprise data on the enterprises 20 in the community and data on the customers C and other enterprises not forming part of the community. In another acceptance, it can be considered that the community in the broad sense comprises active members: the enterprises 20 using the collaborative platform, and the passive members: the customers and prospects C. It should also be noted that an enterprise 20 that is a member of the community may also be a customer C of another enterprise 20 that is a member of the community.

The data on the members 20 are essentially transactional and comprise for example: customer portfolios, invoicing records, invoices, quotations, etc.

The external data, on the customers/prospects C, are essentially financial, supplied by partners of the data provider type, and make it possible to estimate the financial health of the customers and therefore their predisposition to honoring a contractual undertaking such as an invoice that has become due.

The collaborative platform 10 next makes it possible to use the raw data received by performing extraction, processing and prediction operations using the computing means of the platform, before storing the various items of information that will be communicated on the user terminals 25 via the various interfaces.

The information is then presented on the interfaces available for each enterprise using the platform, namely the web interfaces, the mobile applications APP, but also by email. To do this, the API of the collaborative platform makes it possible to make the connection between the user interfaces (consumer programs such as mobile applications and web extensions) and the supplier programs installed in said platform.

The aforementioned operations will be explained in more detail during the description of the prevention method implemented by the collaborative platform. However, it is necessary first to identify the main data exchanged between the collaborative platform and the enterprises in the community.

FIG. 4 shows schematically a user 20 (member enterprise) in its relationship of exchanging data with the collaborative platform 10. The enterprise 20 mainly transmits, automatically via the ERP or manually, payment histories 210 of the customers and payment defaults 220, payment delays or unpaid invoices, noted. As a counterpart, the collaborative platform 10 is able to return to the enterprise 20 prevention information 110 relating to the customers and prospects of said enterprise.

The prevention information 110 contains for example: risk alerts 111, credit risk scores 112 and information reports 113.

A risk alert 111 occurs when a risk analyzed becomes critical and informs for example about an imminent payment default on the part of a customer, about the approach of the due date of a given invoice, about a problematic general situation of a customer, about a disquieting deterioration in the score of a customer, etc. In any event, the risk alert 111 corresponds to an emergency situation and requires priority treatment.

A credit risk score 112 corresponds quite simply to the score attributed by the collaborative platform to a customer or to a given prospect. In one embodiment, the scores are calculated in accordance with known methods such as the notation system described in “Yoshino, Naoyuki & Taghizadeh-Hesary, Farhad. (2015). Analysis of Credit Ratings for Small and Medium-Sized Enterprises: Evidence from Asia. Asian Development Review. 32. 18-37. 10.1162/ADEN_a_00050”.

This notation system makes it possible to calculate for each enterprise a score X ranging from 0 to 10, corresponding to a qualitative financial mark (system of stars on the graphical interfaces for example) and to a credit note further framing the decisions to be taken. The following table gives an example of such a notation:

| Score X | Financial mark | Customer credit mark |
|---|---|---|
| 0 < X < 2.5 | @−−− | Cash payment |
| 2.5 < X < 5 | @−− | |
| X = 5 | @ | |
| 5 < X < 7.5 | @+ | Credit envisageable at 50% |
| 7.5 =< X < 8 | @++ | Customer credit |
| 8 =< X <= 10 | @+++ | |

An information report 113 may, for its part, contain various items of information, classified according to their relevance in decision making or simply presented thematically, and makes it possible to draw up a risk profile for each customer or prospect.

It is important to note that the data supplied by all the enterprises in the community are centralized in the collaborative platform and serve, indifferently according to the models executed, to establish the information intended for each of said enterprises. For example, a given customer may be found in several payment histories supplied by different enterprises, which enables the collaborative platform to reconstitute a payment history particular to said customer, which will have an impact on the predictions obtained with regard to this same customer, and which remains accessible for the enterprises in the community in order to enable them to take transactional decisions involving this customer in full knowledge of the case.

The collaborative platform 10, apart from the prevention information 110, is able to supply to the enterprises 20 that are members of the community additional services, according to the contracts taken out, such as a reimbursement 120 of unpaid invoices, or recovery of debts, thanks to a mutualization of the risks between members of the community; and a mutualized financing of the customer invoices between members of the community based on a peer-to-peer model, which stems from the collaborative aspect of the platform.

In addition, the most sensitive exchanges between the collaborative platform 10 and the enterprises 20 in the community are secured on the blockchain. This firstly relates to the financial and accounting data and the electronically signed contracts as well as cash transfer orders and other monetary operations.

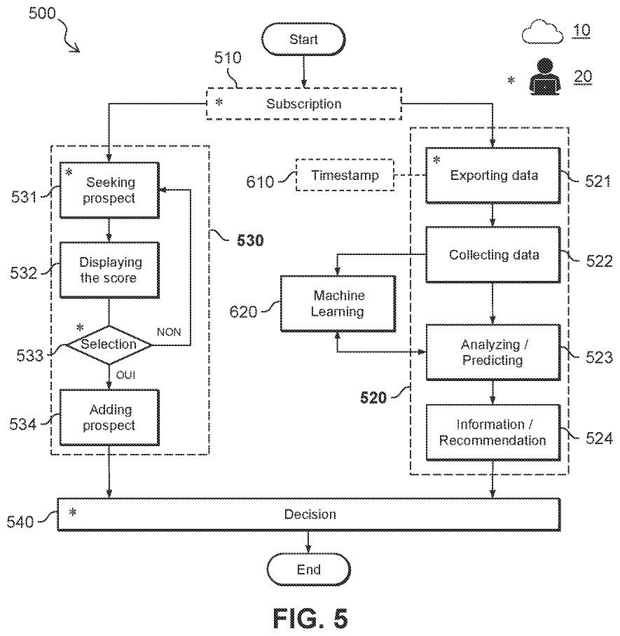

FIG. 5 shows the main steps of a method 500, implemented by the collaborative platform 10, for predicting risks related to payment defaults in an enterprise 20, said prediction consisting of two streams each representing a possible use of said platform, the stream for predicting payment defaults of the customers 520 and the stream for selecting prospects 530.

Before being able to use the collaborative platform 10, each enterprise 20 must take out a subscription 510 to create its user account giving it access to more or less personalized services, according to the requirements of the enterprise, its turnover, its customer portfolio volume, etc.

The subscription 510 is therefore an initial step of the method 500 of predicting risks, and can be implemented by following ordinary steps of online registration and subscription.

For example, the subscription of an enterprise 20 to the collaborative platform 10 is accompanied by the following steps, some of which are obviously optional:
Demonstration of the collaborative platform and of the services offered;
Presentation of the supply of services;
Creation of the profile of the enterprise, by filling in fields of the following type: business sector (list of choices), registration (identity of the enterprise), name of the enterprise, turnover, approximate number of customers, electronic messaging address (email), telephone number, logo of the enterprise, etc.;
Assessment of the supply of services (contractual subscriptions) based on the recorded profile of the enterprise;
Contract proposal followed by an approval on the offer;
Electronic signature of the contract;
Payment of the annual undertaking costs or other;
Publication of the contract signed in electronic form (PDF format for example);
Communication of the user identifiers (identifier and password) for access to the platform and to the user space via the web page or the mobile application;
Establishment of a computer tool for access to the databases of the enterprise either directly by the ERP, or by means of data management software CDMS;
First export of financial and accounting data (customer portfolios, invoicing, etc.) manually or automatically via the enterprise ERP.

The last two steps enable the collaborative platform to collect the first data on the member enterprises. For this purpose, the platform is compatible with various existing ERPs, by means of specific gateways, and is able to collect information such as the customer portfolio, the invoicing history, the quotations, etc.

The collaborative platform is also able to import information compiled in ordinary spreadsheets such as Excel files (Microsoft Excel).

According to one embodiment, establishing the connection between the collaborative platform 10 and the ERP 21 of the member enterprise 20, see FIG. 2, can be done just after the finalizing of the subscription 510. The subscriber, namely a person in the enterprise, receives an email inviting him to download a program that he must install on his computer system. This CDMS program will next enable the enterprise to establish a connection between the collaborative platform and his ERP by choosing the gateway corresponding to his ERP type (among the registered trademarks CIEL, ORACLE, SAP, Microsoft, etc.). Thus this program constitutes a bridge between the accounting system of the member enterprise and the collaborative platform, and enables automated transfer, in real time, of information extracted in a targeted manner so as to supply the platform with any data relevant to the evaluation of the payment default risk.

In the case where the establishment of a bridge between the ERP of the enterprise and the collaborative platform is doubtful or even impossible, said enterprise has the possibility of importing a file of the Excel type into the platform via the web interface or the mobile application so as to share the information contained therein with said platform. The extracted information is next immediately displayed and updated on the various media for access to the platform (web interface and mobile applications).

Hereinafter, it is supposed that the enterprise 20, which counts on using the collaborative platform 10 according to the method 500 in FIG. 5, has completed the subscription step 510 and has successfully registered on said platform.

The risk prediction method 500, in accordance with the payment default prediction aspect 520, comprises mainly:
a step 521 of exporting data on the enterprise 20 to the collaborative platform 10, at one point in time or periodically;
a step 522 of collecting data from the data exported;
a step 523 of analyzing and predicting by executing data-processing and artificial-intelligence algorithms;
an information and recommendation step 524 based on the results of the previous step; and
a final decision step 540 as to the action to be performed by the enterprise 20.

The step 521 of exporting data makes it possible to supply the collaborative platform 10 with financial and accounting data of the enterprises 20 in the community, so that said platform is in a position to identify and predict any payment defaults. The data are exported through the secure connection established between the accounting tool of the enterprise, such as the ERP, and the database of the platform in accordance with the methods presented above (automatic or manual export, CDMS, etc.).

Among the data exported on the collaborative platform, mention can be made of: the customer portfolio, exported at the start, with the possibility of adding new customers subsequently; the invoices, periodically, preferably daily; the history of the customer payments, also periodically, preferably weekly for better prediction of payment defaults.

When a member enterprise forgets to load invoicing or payment history data, reminders are made by the platform by means of notifications on the web interface or on the mobile applications, or by simple emails, inviting said enterprise to update its data for correct functioning of the platform and reliable and up-to-date results.

Secondarily, the exported data can be timestamped 610 in order to establish evidence of dates on said data and to avoid any conflict with an enterprise which, for example, would state that it had not been alerted about lack of payment on an exported invoice, when the latter had truly been exported after the due date.

The step 522 of collecting data by the collaborative platform 10 corresponds to operations of extraction, standardization and classification of the useful data in the database of said platform to allow the execution of the analysis and prediction algorithms. The data collected are next injected into algorithms of the platform such as machine learning models implemented during a permanent machine learning step 620.

The analysis and prediction step 523 makes it possible both to analyze the status of each imported invoice with a view to detecting a payment default in accordance with well established timetable rules, and to predict the occurrence of such a default by automatic learning, taking account of the risk profile of the customers, of time attributes, and of contextual data (financial health of the customers, economic situation of the country of the customer, events, etc.). The prediction of the payment defaults is thus based on the construction of a predictive model from contextual data.

Various types of learning model, supervised or non-supervised, can be used, such as a decision tree model, a grouping model, a Bayesian network model, a probabilistic graphical model, a rule-based model and/or a support-vector machine model. The aforementioned machine learning models can be implemented alone or combined in an artificial neural network architecture, in which case deep learning methods are used.

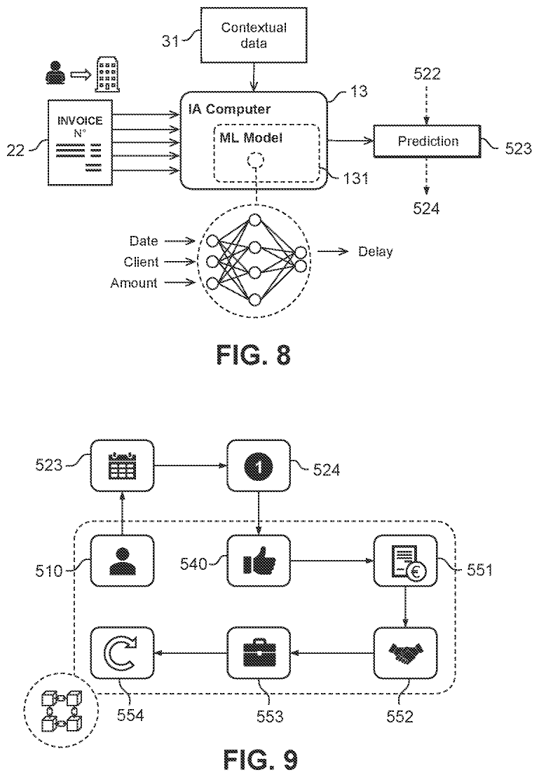

With reference to FIG. 8 and taking as an example a decision tree model 131, the neural network comprises a certain number of nodes, connected by various branches and distributed in layers: input, concealed layers and output. Each node represents a request relating to one or more attributes associated with an invoice 22, the input attributes being for example the date of issue of the invoice, the name of the customer, the amount excluding VAT, etc. The result of a request represented by a current node determines the branch, emanating from the current node, to be followed to reach another node in the neural network. The last node in a particular branch estimates a payment default for the invoice, such as a delay in payment for example.

The analysis and prediction step 523 also makes it possible to predict the cash flow of each enterprise 20 in the community on the basis of the data imported into the collaborative platform. It is a case of a dual prediction of the prediction of the payment defaults. In other words, the prediction of the payment defaults for an enterprise determines, to within a few parameters, the prediction of the cash position of said enterprise.

The prediction of the cash position by virtue of the big data and the machine learning models procures a considerable advantage over the existing solutions, which merely calculate an average for determining statistical tendencies.

The information and recommendation step 524 enables the collaborative platform 10 to provide prevention information (risk alert, and information report), necessary for taking a considered decision on the part of the enterprise 20, and to suggest the most appropriate action having regard to the result of the analysis and the prediction made at the preceding step.

The information obtained is displayed interactively on the various user interfaces (web and mobile application) to allow a simplified reading and immediate access to the information.

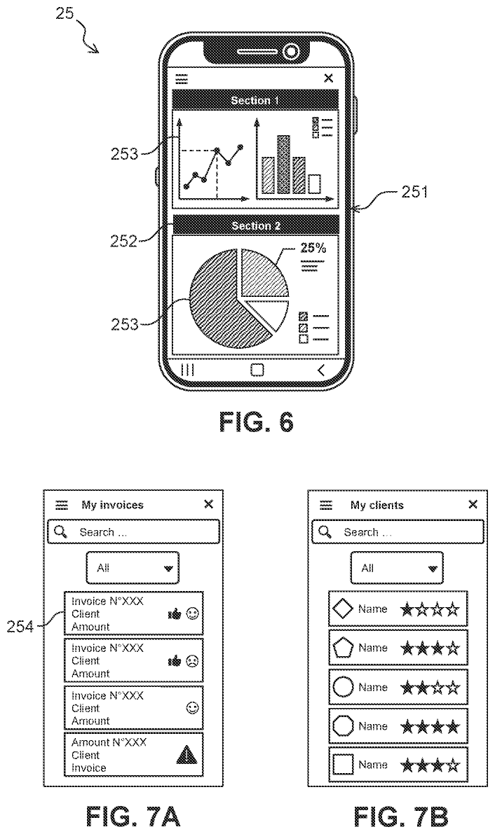

FIGS. 6, 7A and 7B illustrate examples of graphical interfaces 251 for presenting information on a smartphone 25 via a mobile application. The interface may thus include various sections 252 showing the information in the form of curves and graphs 253 (sectors, histograms and others), as well as lists of invoices, quotations, customers and others, allowing access to their elements 254.

Still with reference to FIG. 5, the risk prediction method 500, in accordance with the selection-of-prospects stream 530, mainly comprises:
a step 531 of seeking prospects by the enterprise 20;
a step 532 of displaying the score of the prospects found;
a conditional prospect-selection step 533;
a step 534 of adding prospects to a list of prospects; and
the final decision step 540.

The step 531 of seeking prospects enables the enterprise 20 to seek prospects by means of the collaborative platform 10 in order to access the scores that are attributed to them by said platform. This search may be simple or advanced, with the selection of certain criteria such as the industrial sector, the turnover, the geographical location, etc. The platform is also able to save the preferences of the enterprises that have already carried out searches of prospects.

The step 532 of displaying the score makes it possible to list the various prospects found with the scores that are attributed to them by the collaborative platform according to a notation system as presented above. The presentation of the result of the search with the score can be assimilated graphically to the presentation given in FIG. 7B for the customer portfolio of an enterprise.

The selection step 533 consists in selecting the prospects adopted by the enterprise 20. However, it should be noted that this selection may not be governed by the score displayed. The scores are simple indicators and the final decision is completely down to the enterprise 20 despite the use of the collaborative platform, which is solely a decision-aid tool.

The step 534 of adding the prospects selected by the enterprise 20 makes it possible ultimately to add said prospects to a list that can be consulted via the menu of the web interface or of the mobile application.

The collaborative platform 10 also makes it possible, according to another aspect of the disclosure, to mutualize the risks incurred by the enterprises that are members of the community. In other words, the collaborative platform makes it possible to reimburse all or some of the unpaid invoices suffered by the members of the community that subscribed to this insurance option on the platform.

FIG. 9 represents the unfolding of the process for compensating the balance of a member of the community following an unpaid invoice, said process, taken independently of the rest of the above prevention method, comprises:
a subscription step 510, which can correspond to a first subscription to the collaborative platform with the “insurance” option or to a subscription complementary to the “insurance” service;
an analysis step 523, making it possible to detect an unpaid invoice through the ordinary timetable considerations of exceeding the accepted payment deadlines;
an information step 524, notifying the user of the unpaid invoice noted;
a decision step 540 on the part of the user, attesting to the validity of the unpaid invoice;
a step 551 of generating a compensation for the balance recorded on the virtual portfolio of the user created at the time of the subscription;
a step 552 of validating the compensation by an administrator of the collaborative platform;
a step 553 of transferring the compensation for the balance onto the portfolio of the user; and
a step 554 of updating the portfolio after transfer of the funds.

The collaborative platform thus described enables a community of enterprises to share their customer payment experiences so that each of them can obtain information on the payment history of a given prospect in real time when the latter requests a quotation from them for example, and takes the appropriate decision. In addition, the collaborative platform makes it possible, by means of data collected from various sources, to predict payment defaults by machine learning, thus facilitating the management of the risks on the part of the most vulnerable enterprises such as SMEs.

It is clear from the present description that the collaborative platform and the associated methods can be implemented according to variants, with for example the addition and/or the modification of certain technical features, without departing from the scope of the disclosure. For example the platform can offer functionalities such as the publication of electronic invoices between the members of the community or the periodic sending of a targeted list of prospects that can correspond to the expectations of a member according to data collected in ancillary sources such as social networks.

What is claimed is:

1. Collaborative electronic platform for predicting risk events such as payment defaults between an enterprise and customers of said enterprise, comprising a data storage system, at least one computer server and processing and computing means implementing at least one machine learning model, the platform being able to import data such as financial data of the enterprise by means of a secure connection between the data storage system and an internal management tool of said enterprise, said model estimating the occurrence of risk events on the basis of the data imported, said platform being characterized in that it is connected to a plurality of enterprises forming a community sharing information in real time on the platform, in that it is able to transmit any information shared by a first enterprise to at least one second enterprise in the community for which said information has an interest, and in that it comprises an application programming interface API for executing a risk-management user program on terminals of the enterprises in the community.

2. The collaborative platform according to claim 1, characterized in that it is connected to external data sources, and in that the processing and computing means include notation algorithms for determining a score for any enterprise from information on said enterprise contained in the external data imported by said platform.

3. The collaborative platform according to claim 1, characterized in that it has a cloud architecture with a virtualization layer comprising at least the data storage system and any server, and in that it is accessible via a network of the internet type.

4. The collaborative platform according to claim 1, wherein the data storage system comprises a database and the processing and computing means comprise at least one processor, and wherein said database is distributed on a blockchain.

5. The collaborative platform according to claim 1, wherein the information shared by the member enterprises of the community comprise payment histories of the customers of each enterprise, and wherein the financial data imported comprise customer portfolios and invoices.

6. The collaborative platform according to claim 1, wherein at least one machine learning model constructs a payment-default prediction on an invoice from attributes relating to said invoice, financial data imported on the platform and contextual data.

7. A method for predicting risks related to payment defaults between an enterprise and customers of said enterprise, implemented by a collaborative platform according to claim 1, characterized in that it comprises:
an initial step of subscribing the enterprise to the platform;
a step of exporting data from an internal management tool of the enterprise to the data storage system of the platform;
an analysis and prediction step using at least one machine learning model; and
a step of presenting, on a terminal of the enterprise, information based on results of the previous step.

8. The method according to claim 7, wherein the analysis and prediction step uses data supplied by a plurality of enterprises in the community as well as external data coming from sources such as financial data providers, and makes it possible also to detect payment defaults by taking account of maturity times of invoices imported onto the platform.

9. The method according to claim 7, wherein the information presentation step produces prevention information comprising at least one item of information from a risk alert, a credit risk score and an information report corresponding to the risk profile of a customer of the enterprise.

10. The method according to claim 7, furthermore comprising operations of reimbursement of unpaid invoices in favor of enterprises in the community, in accordance with a risk mutualization system centralized in the collaborative platform and secured by a blockchain.

11. The method according to claim 7, furthermore comprising operations of mutualized financing of customer invoices, between enterprises that are members of the community, in accordance with a peer-to-peer financing model managed by the collaborative platform.

12. The method according to claim 7, wherein the analysis and prediction step comprises a step of predicting the cash position of an enterprise in the community, on the basis of the data imported into said platform.
